(19) United States
(12) Patent Application Publication
(10) Pub. No.: US 2013/0220562 A1
(43) Pub. Date: Aug. 29, 2013

(54) ADJUSTABLE PANELS, SYSTEMS, AND METHODS

(71) Applicants: Steven Michael Jenkins, Raleigh, NC (US); Gregory Scott Barbee, Leasburg, NC (US); William Phillip Unger, JR., Butner, NC (US)

(72) Inventors: Steven Michael Jenkins, Raleigh, NC (US); Gregory Scott Barbee, Leasburg, NC (US); William Phillip Unger, JR., Butner, NC (US)

(21) Appl. No.: 13/528,443

(22) Filed: Jun. 20, 2012

Related U.S. Application Data
(60) Provisional application No. 61/604,943, filed on Feb. 29, 2012.

(51) Int. Cl. F16S 1/02; F16S 5/00

(52) U.S. Cl. 160/368.1; 160/405

(57) ABSTRACT

Novel adjustable panels, systems, and methods are provided. In one aspect, an adjustable panel system can include a first panel, a second panel, and a third panel. The first panel and the second panel can be adjustable to a plurality of adjusted positions with respect to each other in a plurality of fixed increments. The third panel can be adjustably movable with respect to the second panel in increments smaller than the fixed increments. In one aspect, the panels, systems, and methods can be used to provide a portion of a security cage used to house sensitive electrical equipment.

### CROSS-REFERENCE TO RELATED APPLICATION

This application claims the benefit of and priority to U.S. Provisional Application No. 61/604,943, filed Feb. 29, 2012, the entire content of which is incorporated by reference herein.

### TECHNICAL FIELD

The subject matter disclosed herein relates generally to novel panels systems, and methods. More particularly, the subject matter disclosed herein relates to novel adjustable panels, systems, and methods for providing custom sized security caging, for example, for use with data centers and server farms.

### BACKGROUND

Data centers and server farms can be surrounded by security caging to provide a layer of physical protection between sensitive equipment and the general population. The security caging can include punched openings or patterns which provide varying degrees of visual access to the equipment contained therein. It can be important to some customers that the caging be aesthetically pleasing both from a finish and appearance perspective. In this case, the hole or pattern arrangement that provides visual access to the equipment inside of the cage should be clean, with no interruption or breaks in the pattern.

Conventional security caging can include a tubular steel framework anchored to the floor for stability. The framework is usually filled with different sized floor to ceiling panels that provide the necessary visual views and obstruction via the pattern of openings. Providers of most data centers try to maintain a standard footprint for floor plans requiring security cages, typical footprints include an 8′×8′; or an 8′ by 16′ floor plan.

Currently, custom floor plan requests are emerging on a more frequent basis. As a result, conventional security caging must be cut to fit such customized floor plan requests. Current product offering requires the customer to connect consecutive, standard sized panels to complete a “wall” of the security caging. At the end of any given wall, the final panel must be cut to size and a panel fixing angle must be attached to provide a “false side” which is then attached to the vertical framework post to complete that side of the cage. Cutting steel panels on-site is disadvantageous as it is time consuming, potentially dangerous to sensitive equipment and/or personnel, and can contaminate the area with metal shavings.

Despite the availability of various panels, systems, and methods in the marketplace, a need remains for adjustable panels allowing for adjustable security caging having no interruption or breaks in the cage pattern. Such panels should provide custom sized cages without the need to cut panels, where the panels can allow for fixed incremental adjustments and maintain the desired hole-to-hole alignment and pattern so that once installed, the standard panel does not look discernibly different.

### SUMMARY

In accordance with this disclosure, novel adjustable panels, systems, and methods are provided. The panels, systems, and methods described herein can provide adjustable panels well suited for a variety of personal and/or commercial applications such as providing security caging installed about custom sized data centers and/or server farms. It is, therefore, an object of the present disclosure to provide adjustable panels, systems, and methods which offer an aesthetically pleasing appearance and ease of installation, and an alternative to cutting or sawing panels to fit custom sized floor plans.

These and other objects of the present disclosure as can become apparent from the disclosure herein are achieved, at least in whole or in part, by the subject matter disclosed herein.

### BRIEF DESCRIPTION OF THE DRAWINGS

A full and enabling disclosure of the present subject matter including the best mode thereof to one of ordinary skill in the art is set forth more particularly in the remainder of the specification, including reference to the accompanying figures, in which:

FIG. 1 is a perspective view of a first side of an adjustable panel system and adjustable panels according to one aspect of the disclosure herein;

FIG. 2A is a perspective view of the first side of an adjustable panel system according to the disclosure herein;

FIGS. 2B and 2C are enlarged, detail views of the adjustable panels according to FIG. 2A;

FIGS. 3A and 3B are plan views of a second side of an adjustable panel system and adjustable panels in fully closed and fully extended configurations according to the disclosure herein; and

FIG. 4 is a perspective view illustrating an assembled adjustable panel system for use as a security cage according to the disclosure herein.

### DETAILED DESCRIPTION

The subject matter disclosed herein is directed to adjustable panels, systems, and methods for providing security cages, for example, suitable for use and installation about data centers and/or server farms thereby providing a barrier between sensitive electrical equipment and the general population. The adjustable panels, systems, and methods can allow for adjustable security caging without interruptions or breaks in the cage pattern. Notably, such panels, systems, and methods can provide custom sized cages without the need to cut panels, and can further allow for fixed incremental and/or fine adjustments in an overall width of the panel system to maintain the desired hole-to-hole alignment and pattern such that the standard panel does not look discernibly different upon installation. Reference will be made in detail to possible aspects or embodiments of the subject matter herein, one or more examples of which are shown in the figures. Each example is provided to explain the subject matter and not as a limitation. In fact, features illustrated or described as part of one embodiment can be used in another embodiment to yield still a further embodiment. It is intended that the subject matter disclosed and envisioned herein covers such modifications and variations.

As illustrated in the various figures, some sizes of structures or portions are exaggerated relative to other structures or portions for illustrative purposes and, thus, are provided to illustrate the general structures of the present subject matter. Furthermore, various aspects of the present subject matter are described with reference to a structure or a portion being formed on other structures, portions, or both. As will be appreciated by those of skill in the art, references to a structure being formed “on” or “above” another structure or portion contemplates that additional structure, portion, or both may intervene. References to a structure or a portion being formed “on” another structure or portion without an intervening structure or portion are described herein as being formed “directly on” the structure or portion. Similarly, it will be understood that when an element is referred to as being “connected”, “attached”, or “coupled” to another element, it can be directly connected, attached, or coupled to the other element, or intervening elements may be present. In contrast, when an element is referred to as being “directly connected”, “directly attached”, or “directly coupled” to another element, no intervening elements are present.

Furthermore, relative terms such as “on”, “above”, “upper”, “top”, “lower”, or “bottom” are used herein to describe one structure's or portion's relationship to another structure or portion as illustrated in the figures. It will be understood that relative terms such as “on”, “above”, “upper”, “top”, “lower” or “bottom” are intended to encompass different orientations of the component in addition to the orientation depicted in the figures. For example, if a component or feature in the figures is turned over, structure or portion described as “above” other structures or portions would now be oriented “below” the other structures or portions. Likewise, if components in the figures are rotated along an axis, structure or portion described as “above”, other structures or portions would be oriented “next to” or “left of” the other structures or portions. Like numbers refer to like elements throughout.

Unless the absence of one or more elements is specifically recited, the terms “comprising”, including”, and “having” as used herein should be interpreted as open-ended terms that do not preclude the presence of one or more elements.

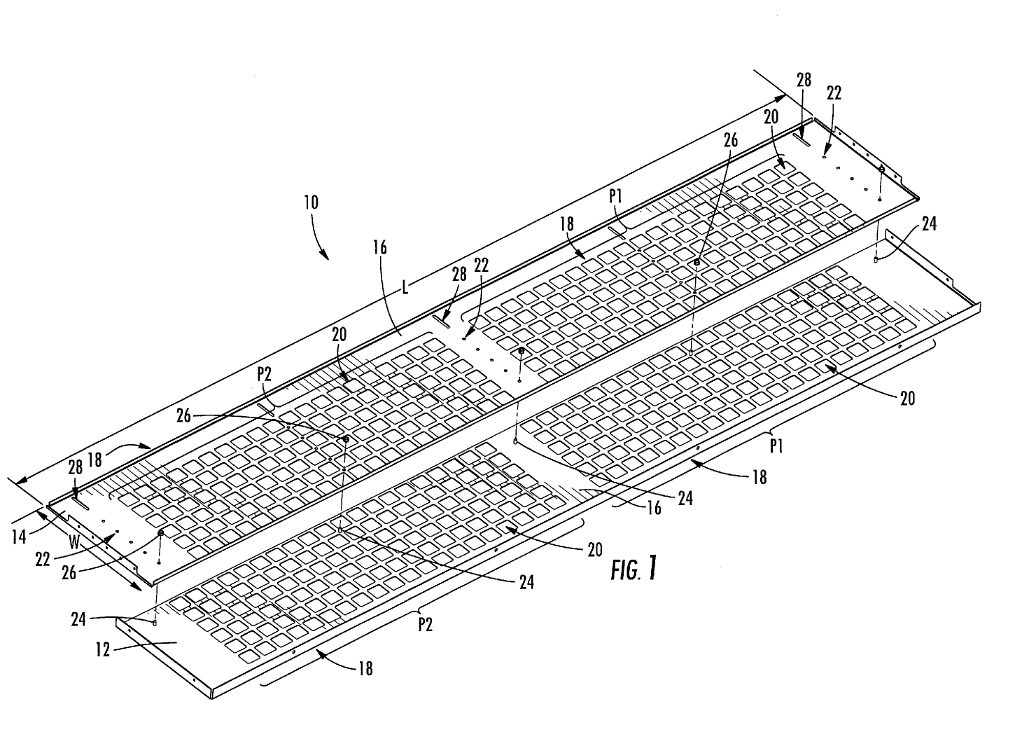

FIGS. 1 through 4 illustrate embodiments of adjustable panels, systems, and methods according to the present subject matter as disclosed and described herein. FIG. 1 is a perspective view of an adjustable panel system, generally designated 10. Adjustable panel system 10 can provide at least a portion of security caging used to house and protect, for example, sensitive electrical equipment, such as data centers and server farms used in the information technology (IT) industry, from the general population. In one aspect, system 10 can connect to a framework of existing panels, and maintain a same pattern as the existing panels. System 10 can comprise at least a first adjustable panel member or first panel 12 and a second adjustable panel member or second panel 14. More than two panels are also contemplated herein. Each of first and second panels 12 and 14, respectively, can comprise elongated panel bodies 16.

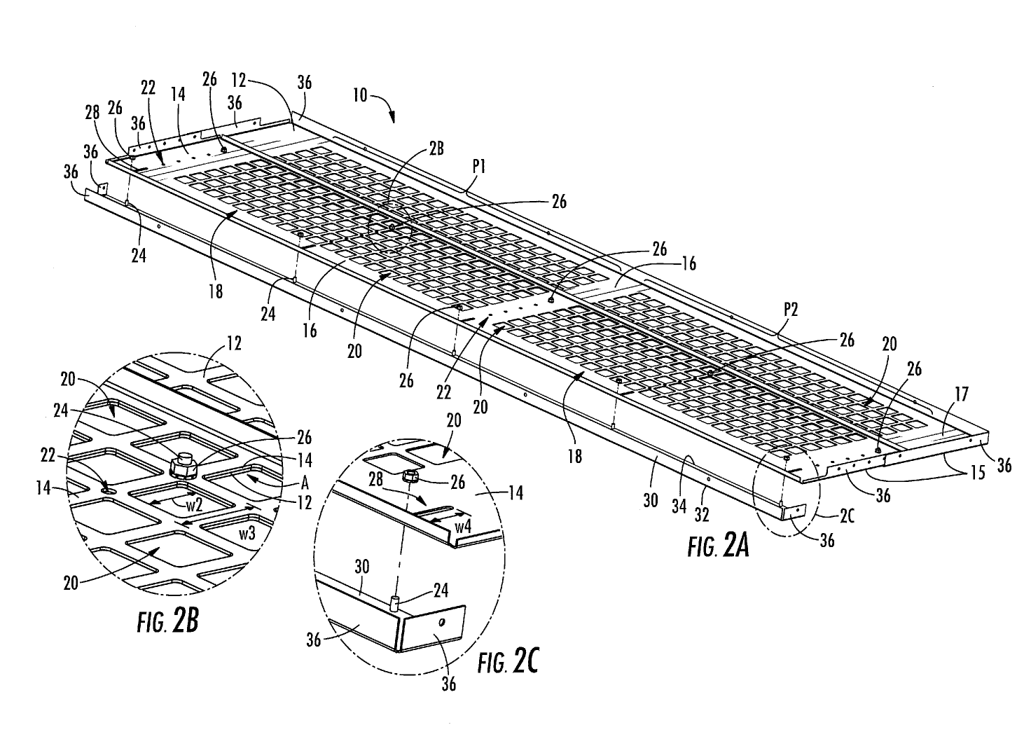

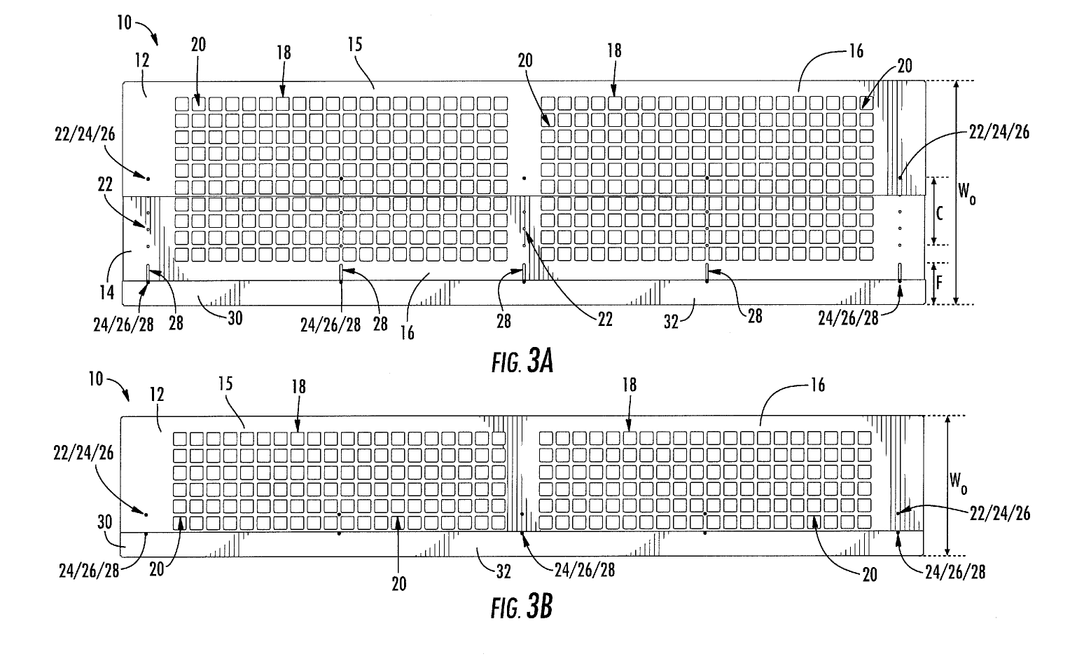

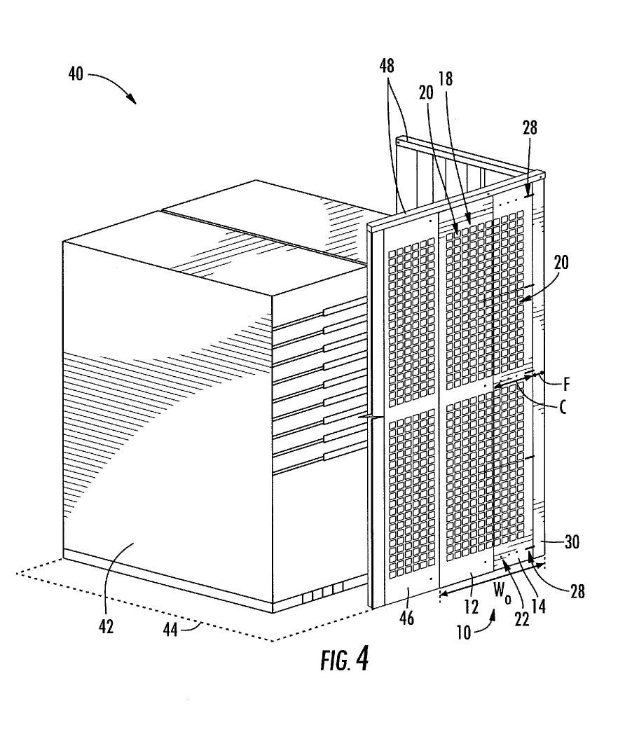

One or more portions of each body 16 can comprise a plurality of openings, such as a pattern of openings generally designated 18. Pattern 18 can comprise at least two openings 20 incrementally spaced apart (e.g., spaced apart a given “hole-to-hole spacing”). Openings 20 can be machined, punched, drilled, or otherwise mechanically formed in elongated panel body for providing visual access to the equipment housed within system 10 (see e.g., FIG. 4). Panel bodies 16 each can comprise a front side 15 and a back side 17. Front side 15 can directly face the general population and provide a view to the equipment housed behind and/or within panel system 10. Back side 17 of system 10 can directly face the equipment to be protected. That is, FIGS. 1 and 2A illustrate the back of the adjustable panel system 10, which is directly proximate the equipment to be protected. FIGS. 3A to 4 illustrate the front of the adjustable panel system 10, which would be directly proximate and visible to the general population.

In one aspect, pattern 18 can be disposed over more than one portion or area of first and second panels 12 and 14, thereby providing visual access substantially the full length and/or width of each panel. In further aspects, more than one pattern 18 can be provided in each panel, for example, pattern 18 can be provided in a first portion P1 of panels 12 and 14 and also in a second portion P2 of panels 12 and 14. Patterns 18 provided in first and second portions P1 and P2 can comprise the same pattern and/or different patterns. That is, a pattern provided or disposed in first portion P1 can be the same as a pattern disposed in second portion P2 for each panel, or, in the alternative, a pattern provided and disposed in first portion P1 can be different from a pattern disposed in second portion for each panel. For illustration purposes, each pattern 18 in portions P1 and P2 of first and second panels 12 and 14 is shown to be the same (e.g., same size and hole-to-hole spacing of openings 20), however, different patterns are also contemplated herein, as well as different sizes and shapes of openings 20. Notably, first and second panels 12 and 14 can be assembled together such that portions P1 and P2 generally align. Thus, each portion P1 and P2 on each panel 12 and 14 can comprise the same pattern having the same size and hole-to-hole spacing of openings 20. In one aspect, patterns 18 can be non-centrally disposed (e.g., off-center) with respect to a longitudinal centerline or axis (not shown) of each of first and second panels 12 and 14. That is, patterns 18 can be disposed proximate an edge of each of first and second panels 12 and 14, respectively, such that a uniform and centralized pattern can result over the joined first and second panels 12 and 14.

Each of first and second panels 12 and 14 can comprise the same length and width, or different lengths and widths. In one aspect, first and second panels 12 and 14 can comprise panels selected from a range of available lengths and widths. For example, first and second panels 12 and 14 comprise a length L of less than approximately 40 feet (ft) or (′); approximately 20′ or less; approximately 15′ or less; approximately 10′ or less; approximately 9′ or less, or approximately 8′ or less, such as approximately 92.375 inches (in) or (″) for fitting against a frame member or post extending from the ceiling, which has a length of a couple of inches. In one aspect, length L can correspond to a length between the floor and ceiling, or a size of the electrical equipment to be housed behind system 10. First and second panels 12 and 14 can comprise a width W of less that approximately 4′; approximately 3′ or less; approximately 2′ or less; approximately 18″; approximately 16″ or less; approximately 15″ or less; approximately 13″ or less; approximately 12″ or less; or less than 6″. Any dimension of L and/or W is contemplated herein, and can be specified by a customer of such panels and systems as described herein.

Still referring to FIG. 1, first and second panels 12 and 14 can be adapted or configured to engage, connect, lock, join, and/or assemble together for providing at least a portion of a security cage. Notably, when first and second panels 12 and 14 are engaged or joined, an overall width (Wₒ, FIGS. 3A and 3B) of the joined panels can be adjusted to a custom width (e.g., a predetermined width), and the one or more patterns 18 disposed in first and second portions P1 and P2 of each panel can be maintained across the joined panels, without any break or interruption in the pattern(s) (see e.g., FIGS. 3A and 3B). In one aspect, each pattern 18 can comprise an area of square shaped openings 20; however, non-square shaped openings such as circular, rectangular, triangular, regular, irregular, or asymmetrical openings 20 are also contemplated herein. Each opening 20 can comprise a square having sides in length and width of approximately 4″ or less (e.g., an area of approximately 16 in² or less); approximately 2″ or less; approximately 1.5″ or less; approximately 1″ or less, or approximately 0.5″ or less. However, any size and/or shape of openings 20 are contemplated herein. Each opening 20 can be uniformly spaced apart from at least one adjacent opening, such that a uniform hole-to-hole spacing is established.

First panel 12 can comprise an adjustable main panel, to which second panel 14 can assemble and join thereto. Second panel 14 can comprise a middle panel, to which first panel 12 and an optional, third panel member or end panel (e.g., 30, see FIG. 2A) can join thereto. Notably, second panel 14 can comprise areas providing for coarse and fine adjustments, which can allow the joined first, second, and third panel members to adjust to an overall predetermined width between a fully closed and a fully extended position or configuration. Second panel 14 can comprise at least two adjustment holes 22 for providing a plurality of coarse, fixed increment adjustments to an overall width of joined first and second panels, 12 and 14, respectively. Second panel 14 can further comprise one or more slots 28 for providing fine adjustments to the overall width of joined first, second and end panel members, 12, 14, and 30 (FIG. 2A), respectively. The fine adjustments between second and end panels 14 and 30, respectively, can be smaller than the fixed increment adjustments between first and second panels 12 and 14. Notably, adjustment holes 22 can be spaced apart a first width that is approximately equal to or greater than the width of at least one opening 20 such that openings 20 of first and second panels 12 and 14 align at each fixed increment adjustment. Adjustment holes 22 can be positioned in any location and/or in any number or configuration over second panel 14. Adjustment holes 22 can allow fixed increment adjustments (e.g., increases or decreases) in a distance between first panel 12 and second panel 14, such that the overall width of the assembled panels 12 and 14 can be incrementally adjusted to fit a custom sized space, area, floor plan, or piece of equipment.

Adjustment holes 22 can be configured to engage with and/or fit into one or more pins 24 disposed on first panel 12. Second panel 14 can be assembled or joined together with first panel 12 by insertion of one or more pins 24 into one or more adjustment holes 22. In one aspect, pins 24 can be threaded for fixedly engaging with one or more locking nuts 26. Each locking nut 26 can comprise a threaded inner surface adapted to engage and communicate with a threaded outer surface of each pin 24, for fixedly attaching and locking first panel 12 to second panel 14 by frictional and threaded engagement between locking nut 26 and pin 24. Together, holes 22, pins 24, and locking nuts 26 can comprise a locking mechanism configured to attach and lock first and second panels 12 and 14 together in a desired configuration. However, any other generally known locking mechanism(s) or attachment feature(s) is contemplated herein, in addition to and/or instead of the hole 22 and threaded pin 24 and nut 26 locking mechanism, for example, bolts, screws, hooks, clips, or any other generally known and available locking mechanism(s) are contemplated herein.

Notably, the spacing of the locking mechanisms is advantageous, as it can allow the panels to incrementally adjust by a predetermined or fixed width or distance, and maintain a uniform pattern having uniform hole-to-hole spacing over portions P1 and P2 of joined panels, even when adjusted, as the spacing of pins 24 and adjustment holes 22 can correspond to the distance between openings 20 of pattern 18. For example, the spacing between two adjustment holes 22 can comprise a distance or width that is approximately equal to or greater than the width of the at least one opening. That is, spacing between adjustment holes 22 can comprise a distance of approximately 4″ or less; approximately 2″ or less; approximately 1.5″ or less; 1″ or less, or 0.5″ or less, and can comprise a same width as and/or be slightly wider than openings 20. First panel 12 and second panel 14 can be adjustable to a plurality of adjusted positions with respect to each other in a plurality of fixed increments.

As FIG. 1 illustrates, second panel 14 can comprise more than one row of at least two adjustment holes 22. In one aspect, second panel 14 can comprise five rows of five incrementally spaced adjustment holes 22 along the length of body 16 (e.g., 25 total adjustment holes 22). Each row of adjustment holes can substantially span across the width of second panel 14. Notably, at least one row of adjustment holes 22 can be disposed within pattern 18, and can be positioned in between and/or adjacent one or more opening 20. More than one row of adjustment holes 22 can span the length and/or width of second panel 14.

Second panel 14 can further comprise one or more slots 28 provided in panel body 16. Slots 28 can comprise an opening adapted to receive a pin 24 of an adjacent panel, such as end panel 30 (FIG. 2A). Slots 28 can be disposed and positioned along an outer edge of second panel 14, on a side opposing where second panel 14 can join with first panel 12. Notably, second panel 14 can comprise a middle panel which allows for both coarse adjustment in overall width between the middle panel and a first adjacent panel (e.g., first panel 12) along one side, as well as a fine adjustment in overall width between the middle panel and a second adjacent panel (e.g., end panel 30, FIG. 2A) along an opposing side. Thus, system 10 can comprise a middle panel, such as second panel 14, where width of the system can be adjusted either incrementally via adjusting and locking pins 24 into different holes 22 and/or slidably via sliding and locking pins 24 in slots 28 such that the overall width (Wₒ, FIGS. 3A and 3B) of system 10 can adjust and fit into and/or enclose a custom sized area without requiring the panels to be cut or sawn. First panel 12 and second panel 14 can be adjustable to a plurality of adjusted positions with respect to each other in a plurality of fixed increments. End panel 30 can be adjustably movable with respect to second panel 14 in increments that are smaller than the fixed increments (e.g., fine-tuned adjustments).

FIG. 2A illustrates a further embodiment of adjustable panel system 10, further comprising end panel 30. As FIG. 2A illustrates, first and second panels 12 and 14 can be assembled or connected such that the patterns 18 on each portion P1 and P2 of each panel 12 and 14, respectively, overlap. Patterns 18 can be centrally disposed with respect to the joined panels. First and second panels 12 and 14 can thus form a single, uniform pattern upon assembly, where the pattern has no noticeable breaks or interruption between openings 20. This can advantageously allow customers to have uniform, non-obstructed visibility to equipment positioned behind the panels, such that a user can quickly scan equipment approximately the full length and width of the assembled panels as needed to assess equipment for failures, problems, or to assure the equipment is working properly.

Notably, the spacing of adjustment holes 22 can correspond to the spacing between openings 20, and/or the widths of openings 20, such that the patterns on panels 12 and 14 can align, and be incrementally adjusted to fit a custom size floor plan or space. First and second panels 12 and 14 can be assembled or locked together via positioning one or more pins 24 of first panel 12 through one or more aligned adjustment holes 22 of second panel 14, and then tightening one or more locking nuts 26 over each pin 24. End panel 30 can then be assembled and connected to second panel 14 for fine adjustment of the overall width of system 10. One or more pins 24 of end panel 30 can be positioned through one or more slots 28 of second panel 14. Pins 24 of end panel 30 can slidably adjust within slots 28 to a desired configuration. Upon reaching the desired configuration (e.g., width or spacing between second panel 14 and end panel 30), one or more locking nuts 26 can threadingly engage and be tightened over pins 24 of end panel 30 that are positioned in slots 28, such that second panel 14 and end panel 30 can be connected and locked together.

End panel 30 can comprise a body having a front side 32 and a back side 34. Front side 32 can directly face the general population for providing a view to the equipment housed behind and/or within panel system 10. Back side 34 of end panel 30 can directly face the equipment to be protected. End panel 30 can comprise a strip panel portion that is narrower than the first and second panels 12 and 14. In one aspect, each of first, second, and end panels 12, 14, and 30, respectively, can comprise one or more outer tabs 36 disposed about the perimeter of each panel. Tabs 36 can be configured to engage with framework, such as a frame or post (e.g., 48, FIG. 4), to be secured thereto for securing panel system 10 to the frame or cage. Tabs 36 can also be configured to engage with one or more existing panels (e.g., 46, FIG. 4) for connecting system 10 to an existing portion of a security cage. In one aspect, system 10 can comprise a portion of a security cage, and allows that portion of the security cage to be adjusted for fitting into a custom sized space and/or over a custom sized floor plan without having to saw or cut panels.

FIG. 2B is a detailed view of circle 2B in FIG. 2A. As FIG. 2B illustrates, adjustment holes 22 can be spaced apart at least equal to or greater than a width w2 of openings 20. For example, adjustment holes 22 provided in second panel 14 can advantageously be spaced apart a width w3 and allow incremental adjustments between first and second panels 12 and 14, such that the openings 20 of respective panels align, and an overall width of the assembled panels can be adjusted without breaking or interrupting the pattern and/or the hole-to-hole spacing between openings 20 formed across both panels. Width w3 can equal to and/or be slightly wider than width w2. For example, widths w2 and w3 can comprise a width of approximately 4″ or less; approximately 2″ or less; approximately 1.5″ or less; approximately 1″ or less, or approximately 0.5″ or less. However, any widths w2 and w3 are contemplated herein. Once the panels are in the desired position with respect to each other, locking nut 26 can be tightened over pin 24 of first panel 12. As FIG. 2B illustrates, portions of first and second panels 12 and 14 can overlap as indicated by arrow A which points to an area of stacked or overlapping panels, and respective openings 20 of each panel can align, thus, providing a continuous pattern and hole-to-hole spacing of openings 20 across the joined panels. In one aspect, first and second panels 12 and 14 are configured to be adjustably movable into a plurality of adjusted positions via providing pins of first panel 12 into different adjustment holes 22 of second panel 14. Notably, openings 20 disposed in each of the first and second panels 12 and 14 can be aligned in each of the plurality of adjusted positions.

FIG. 2C is a detailed view of circle 2C in FIG. 2A. As FIG. 2C illustrates, end panel 30 can comprise one or more pins 24 configured to engage a portion of the one or more slots 28 of second panel 14. Each pin 24 of end panel 30 can enter into and slide along a width w4 of each given slot 28 such that a portion of panel system 10 can be slidably adjusted to a desired width, thereby compressing and/or extending to fit within a desired space of a predetermined width. Slot 28 can allow for fine adjustments in width of system 10, whereas adjustment holes 22 (FIG. 2B) can provide coarse, or incremental adjustments in overall width. Once the width of second panel 14 and end panel 30 is adjusted to a desired width via slidable adjustment of pin 24 within slot 28, a locking nut 26 can engage pin and lock or secure end panel 30 to a desired position with respect to second panel 14.

FIGS. 3A and 3B illustrate different configurations of system 10. FIGS. 3A and 3B are front views of system 10 (e.g., a view of front sides 15 and 32 of respective panels) as it would appear to consumers, or members of the general population, for viewing equipment through the panel system 10. FIG. 3A illustrates system 10 in a fully extended configuration. FIG. 3B illustrates system 10 in a fully closed or retracted configuration. As the figures illustrate, an overall width Wₒ of system 10 can be adjusted between the fully extended and fully closed configurations for allowing system 10 to fit within a given space and/or over a given width of floor plan without having to saw or cut panels to size. During adjustment of first and second panels 12 and 14, portions of first panel 12 can overlap portions of second panel 14 by variable increments and/or variable amounts thereby allowing overall width Wₒ to be lengthened or shortened. As FIG. 3A illustrates, a portion of second panel 14 can be minimally overlapped by a portion of panel 12, as the panels can join by locking pin 24 into an outermost adjustment hole 22 via locking nut 26 (e.g., as indicated by the darkened circles with reference character 22/24/26). That is, a portion of first panel 12 can be positioned adjacent a portion of second panel 14 such that one or more pins 24 extend into and become secured within the outermost adjustment hole 22 as indicated by 22/24/26. The outermost adjustment hole 22 can be the hole closest to an outermost longitudinal edge of second panel 14, which is not the same as and which opposes the longitudinal edge having one or more slots 28. FIG. 3A illustrates the fully extended position where Wₒ is maximized by fully extending each of first panel 12 and end panel 30 the maximum width away from middle, second panel 14.

The distance between first and second panels 12 and 14 and/or the amount of overlap between both panels can be incrementally adjusted to a plurality of positions and a plurality of fixed increments (e.g., via coarse adjustments to different adjustment holes 22) to expand and/or shorten overall width Wₒ of system 10 as indicated by the arrow C. The distance between panels can be varied by varying the placement of pin 24 of first panel 12 into different adjustment holes 22 of second panel 14. First and second panels 12 and 14 can be adjusted with respect to each other by positioning one or more pins 24 of first panel 12 into different adjustment holes 22 of second panel, for maintaining a continuous, unbroken pattern 18 across one or more portions (e.g., P1 and P2, FIG. 1) of the joined panels. Notably, pattern 18 can be centrally disposed across the joined first and second panels 12 and 14, such that pattern 18 can span substantially the full length and/or substantially span the full width of the joined panels, creating a uniform hole-to-hole spacing and unobstructed view.

As FIG. 3A further illustrates, end panel 30 can be disposed in a configuration where it fully extends to an outermost position from second panel 14, thereby further increasing overall width Wₒ. For example, one or more pins 24 disposed on end panel 30 can slide and lock into the farthest position along slot 28 that is disposed farthest from panel 14. The distance between and/or a width of second panel 14 and end panel 30 can be fine-tuned as indicated by arrow F, by slidably adjusting one or more pins 24 of end panel 30 along the width (e.g., w4, FIG. 2C) of slot 28. The darkened circles 24/26/28, and 22/24/26 of FIGS. 3A and 3B indicate the position of locked or secured pins 24 within system 10. Overall width Wₒ of system 10 can be incrementally adjusted and/or finely adjusted (e.g., shortened) by various degrees from the fully extended configuration illustrated in FIG. 3A by adjusting pin 24 positions within adjustment holes 22 and/or slots 28 of second panel 14. Notably, such adjustments can allow system 10 to fit within a custom sized frame or floor space without having to saw or cut panels.

FIG. 3B illustrates system 10 in a fully closed configuration, in which overall width Wₒ can be minimized. In this embodiment, first panel 12 can substantially fully overlap second panel 14 by positioning one or more pins 24 into the first adjustment hole 22 in a given row of holes. The first adjustment hole 22 in a given row of holes can correspond to the hole that is closest in proximity to one or more slots 28. In the fully closed embodiment, one or more pins 24 of end panel 30 can also slide into and be positioned into the most inboard position along slot 28, for example, the area of slot 28 that is farthest away from the longitudinal edge to which one or more slots 28 and closest in proximity to the first adjustment hole 22. In the fully closed embodiment, the panels can be adjusted and locked such that pins 24 of first panel 12 are disposed adjacent pins 24 of end panel 30.

Overall Wₒ in the fully extended embodiment illustrated in FIG. 3A can comprise approximately 96″ or less; approximately 72″ or less; approximately 49″ or less; approximately 45″ or less; approximately 27″ or less (e.g., 26.5″ or 25.8″); or approximately 24″ or less, and can depend upon width of first, second, and end panels 12, 14, and 30, respectively. Overall width Wₒ in the fully closed embodiment illustrated in FIG. 3B can comprise approximately 48″ or less; approximately 30″ or less (e.g., 26.5″); approximately 26″ or less; approximately 20″ or less (e.g., approximately 16.2″ or 15.5″); or approximately 12″ or less. Overall width Wₒ of system 10 can comprise any suitable dimension, and can be adjusted to any width or sub-range of widths between, for example, the fully closed and fully extended embodiments such as between approximately 12″ and 96″.

FIG. 4 shows a partially assembled security cage, generally designated 40. Security cage 40 can be disposed about a piece of electrical equipment 42. In one aspect, security cage 40 can be required to enclose a space of a predetermined size, such as a custom sized floor plan or floor space 44. In order to adapt to a custom size without cutting, at least a portion of security cage 40 can comprise adjustable panel system 10 for adjusting to fit into the desired floor space 44 without cutting or sawing one or more panels. Notably, pattern 18 across portions of joined panels (e.g., first and second panels 12 and 14) can be maintained across any coarse or fine adjustment in distance or width between first, second, and third panels 12, 14, and 30 and a hole-to-hole spacing of openings 20 can be substantially uniform across system 10. System 10 can be positioned adjacent to and can connect with an existing panel 46 of security cage 40 via tabs (e.g., 36, FIG. 2A). System 10 can also connect to a framework structure, such as posts 48 of the security cage 40 via tabs (e.g., 36, FIG. 2A).

In one aspect, a method of providing and/or adjusting a panel system can comprise joining or assembling the first panel 12 to a second panel 14. In one aspect, first panel 12 can be fixed or locked into place with existing panel 46. Thus, at least one adjustment hole 22 from each row of adjustment holes of second panel 14 can be positioned over correspondingly spaced pins 24 provided in first panel 12. The method can include adjusting a width of the joined first and second panels incrementally to fit, or almost fit into a portion of a predetermined space or floor space 44, where any remaining space not filled by first and second panels 12 and 14 can be filled by a portion of end panel 30. In one aspect, the adjustment holes 22 that are closest in width to fit an opening in a security cage 40 can be chosen (e.g., the opening between panel 46 and the corner where posts 48 meet) and placed over pins 24 of fixed, first panel 12. In one aspect, first and second panels 12 and 14 can be adjusted to within approximately ¼″ to approximately 2 and ⅛″ of the cage opening. First and second panels 12 and 14 can be locked together via locking nuts threaded over pins 24. One edge of first panel 12 can optionally be provided adjacent to and joined with an existing panel 46 and frame and/or post 48 of security cage 40. Thus, first panel 12 can be fixed in place, and the second panel 14 can be adjusted to the approximate width required by positioning and locking pins 24 of first panel 12 into adjustment holes 22 of second panel 14.

End panel 30 can permit fine-tuning of system 10 for a precise fit. The method can further comprise joining end panel 30 to second panel 14. End panel 30 can be joined to an edge of second panel 14 which opposes the edge attached to first panel 12. Pins 24 of end panel 30 can be placed in slots 28 of second panel 14. The method can further comprise adjusting a width between end panel 30 and second panel 14 to fit the desired floor space 44. End panel 30 can be slidably adjusted to close the opening or gap between the second panel 14 and the end of the desired floor space 44 by sliding and locking pins 24 of end panel into slots 28 of second panel 14. End panel 30 can then be secured to upper framework posts 48 and/or a vertical frame or post for providing a closed security cage disposed about equipment 42. Notably, panels 12, 14, and 30 can be adjusted such that a pattern 18 of uniform hole-to-hole spacing can be maintained across the joined panels, which can be the same as a pattern as other portions of security cage. Each of the panels can be configured to adjust, either incrementally and/or slidably, and upon reaching the desired adjustment in width, the panels can be configured to lock into place with respect to each other, thereby forming a panel assembly.

Embodiments of the present disclosure shown in the drawings and described above are exemplary of numerous embodiments that can be made within the scope of the appended claims. It is contemplated that the novel joint devices, systems, and methods described herein can comprise numerous configurations other than those specifically disclosed.

What is claimed is:

1. An adjustable panel comprising:
an elongated panel body comprising a pattern of openings, wherein each opening comprises a first width;
at least two adjustment holes provided in the panel body, wherein the at least two adjustment holes are spaced apart a second width that is approximately equal to or greater than the first width; and
at least one slot provided in the panel body;
wherein the at least two adjustment holes and the at least one slot are configured to assemble with portions of adjacent panels for adjusting the assembled panels to a predetermined width.

2. The adjustable panel according to claim 1, wherein the pattern of openings is off center with respect to a centerline of the elongated panel body.

3. The adjustable panel according to claim 1, wherein the panel is configured to assemble with an adjacent panel having the same pattern.

4. The adjustable panel according to claim 1, wherein the at least two adjustment holes are disposed between openings.

5. The adjustable panel according to claim 1, wherein the elongated panel body comprises a length of approximately 9 feet (′) or less.

6. The adjustable panel according to claim 5, wherein the elongated panel body comprises a length of approximately 8′ or less.

7. The adjustable panel according to claim 1, comprising five rows of adjustment holes disposed along a length of the elongated panel body.

8. The adjustable panel according to claim 1, comprising five slots disposed along an edge of the elongated panel body.

9. An adjustable panel system comprising:
a first panel;
a second panel;
a third panel;
wherein the first panel and the second panel are adjustable to a plurality of adjusted positions with respect to each other in a plurality of fixed increments; and
wherein the third panel is adjustably movable with respect to the second panel in increments smaller than the fixed increments.

10. The adjustable panel system according to claim 9, wherein each of the first and second panels comprise a plurality of openings, and wherein the first and second panels are adjustably movable such that the openings in each of the first and second panels are aligned in each of the plurality of adjusted positions.

11. The adjustable panel system according to claim 9, wherein the first panel is in a fixed position and the second panel is adjustably movable with respect to the first panel.

12. The adjustable panel system according to claim 9, wherein the second panel comprises at least one slot for precise adjustment of the third panel.

13. The adjustable panel system according to claim 9, wherein each of the panels is configured to lock in place with respect to each other thereby forming a panel assembly.

14. The adjustable panel system according to claim 9, wherein the panel system is adjustably movable without cutting any of the panels.

15. The adjustable panel system according to claim 9, wherein the second panel comprises a middle panel that is adjustably movable with respect to the first panel.

16. The adjustable panel system according to claim 9, wherein the third panel comprises an adjustably movable end panel.

17. The adjustable panel system according to claim 9, wherein the third panel comprises a strip panel portion that is narrower than the first and second panel.

18. A method of providing an adjustable panel system, the method comprising:
providing a first panel, a second panel, and a third panel;
adjusting the second panel with respect to the first panel, wherein the second panel is adjustable to a plurality of positions with respect to the first panel in a plurality of fixed increments; and
adjusting the third panel with respect to the second panel, wherein the third panel is slidably adjustable to increments smaller than the fixed increments.

19. The method according to claim 18, further comprising providing a plurality of openings in each of the first and second panels, and wherein the first and second panels are adjustably movable such that the openings provided in each of the first and second panels are aligned in each of the plurality of adjusted positions.

20. The method according to claim 18, wherein adjusting the second panel with respect to the first panel comprises positioning an adjustment hole of the second panel over a pin of the first panel.

21. The method of claim 20, further comprising locking the pin into the adjustment hole.

22. The method according to claim 18, wherein adjusting the third panel comprises sliding one or more pins disposed in the third panel along one or more slots disposed in the second panel.

23. The method according to claim 22, further comprising locking the one or more pins of the third panel into the one or more slots of the second panel after slidably adjusting the third panel with respect to the second panel.
